(19) United States
(12) Patent Application Publication
(10) Pub. No.: US 2020/0122451 A1
(43) Pub. Date: Apr. 23, 2020

(54) SURFACE FINISHES AND METHODS FOR PROVIDING SURFACE FINISHES TO A SUBSTRATE

(71) Applicant: PRECOAT METALS CORP., St. Louis, MO (US)

(72) Inventor: KELVIN RUSSELL, KATY, TX (US)

(21) Appl. No.: 16/601,987

(22) Filed: Oct. 15, 2019

Related U.S. Application Data
(60) Provisional application No. 62/747,436, filed on Oct. 18, 2018.

(51) Int. Cl. B41C 1/02; B23K 26/362; B23K 26/361

(52) U.S. Cl. CPC B41C 1/02; B23B 2226/31; B23K 26/361; B23K 26/362

(57) ABSTRACT

A method for providing a textured surface finish to a substrate includes providing an image having a contrast ratio; altering the image to increase the contrast ratio; determining an engraving profile for an ink transfer tool based on the contrast ratio of the image; etching the ink transfer tool in accordance with the engraving profile; coating the ink transfer tool with an ink; transferring the ink from the ink transfer tool to a substrate; applying a top coat to the substrate while the ink is set; and curing the ink and top coat on the substrate in an oven. The etching creates a plurality of wells in the ink transfer tool for holding the ink. The engraving profile is not identical to the altered image.

### CROSS-REFERENCE TO RELATED APPLICATIONS

This application claims priority to U.S. Provisional Patent Application No. 62/747,436, filed Oct. 18, 2018, the entire disclosure of which is incorporated by reference herein.

### FIELD OF THE INVENTION

This invention is related to coatings for substrates. More particularly, the invention is directed to methods of providing an aesthetic surface finish to a substrate, such as coiled sheet metal.

### BACKGROUND

Sheet metal is utilized in many industries to fabricate myriad of products including but not limited to doors and windows, home appliances (e.g., HVAC, ovens, dishwashers, washing machines, etc.), and storage containers. Because such products are often visible, it is desirable for the sheet metal to be coated to provide an aesthetic and tactile exterior surface. Typically, there is limited ability to achieve a desired aesthetic and tactile appearance due to limitations of the coatings themselves. Coatings, and methods of applying such coatings, are described herein which overcome the previous limitations and allow superior surface finishes to be applied to substrates, including but not limited to sheet metal.

### SUMMARY

The following presents a simplified summary of the invention to provide a basic understanding of some aspects thereof. This summary is not an extensive overview of the application. It is not intended to identify critical elements of the invention or to delineate the scope of the invention. Its sole purpose is to present some concepts of the invention in a simplified form as a prelude to the more detailed description that is presented elsewhere herein.

In one embodiment, a method for providing a textured surface finish to a substrate includes providing an image having a contrast ratio; altering the image to increase the contrast ratio; determining an engraving profile for an ink transfer tool based on the contrast ratio of the image; etching the ink transfer tool in accordance with the engraving profile; coating the ink transfer tool with an ink; transferring the ink from the ink transfer tool to a substrate; applying a top coat to the substrate while the ink is set; and curing the ink and top coat on the substrate in an oven. The etching creates a plurality of wells in the ink transfer tool for holding the ink. The engraving profile is not identical to the altered image.

According to another embodiment, a method for providing a textured surface finish to a substrate includes providing an image having a contrast ratio, and altering the image to increase the contrast ratio. The method continues by determining an engraving profile for an ink transfer tool based on the contrast ratio of the image. The ink transfer tool is then etched in accordance with the engraving profile, and the ink transfer tool is coated with an ink. A substrate is prepared by coating it in a base coat, after which the ink from the ink transfer tool is transferred to the substrate. A top coat is applied to the substrate while the ink is set, and the ink and top coat is then cured on the substrate in an oven. The etching of the ink transfer tool creates a plurality of wells in the ink transfer tool for holding the ink.

In still another embodiment, a method for providing a surface finish to a substrate includes first providing an image having a contrast ratio. An image provide is determined for an ink transfer tool based on the contrast ratio of the image, and the ink transfer tool is prepared in accordance with the image profile. Preparing the ink transfer tool includes defining a plurality of wells in the ink transfer tool. The ink transfer tool is coated with an ink, wherein the ink is retained in the wells. Ink is then transferred from the ink transfer tool to a substrate, and a top coat is applied. The substrate is then cured in an oven.

### BRIEF DESCRIPTION OF THE DRAWINGS

FIG. 1 shows two images of drawdowns in grey scale showing effects of engraving techniques on a printed image.

FIG. 2 shows a gloss curve for a half-tone laser printed screen.

FIG. 3 is a microscopic image of a pattern showing the effect of ink on a top coat.

FIG. 4 is another microscopic image of a pattern shown the effect of ink on a top coat.

FIG. 5 is a photograph of a single-color coating design applied to substrate to form a textured pattern according to an embodiment of the invention.

FIG. 6 is a photograph of a dual-color coating design applied to a substrate to form a textured pattern according to another embodiment of the invention.

### DETAILED DESCRIPTION

Decorative finishes for a substrate, including sheet metal, are often applied as either a single-color coating, or a dual-color coating. Dual-color coatings can be, and traditionally have been, applied to substrates to simulate patterns, such as a wood grain pattern or camouflage. However traditional coatings are limited in the surface finish they can provide on the substrate because the coating tends to be glossy and has no appreciable texture. To compensate, some coatings include beaded media, or solid additives, that provide a texture to the coating. However, the additives are dispersed throughout the coating, and therefore the texture is not specific to any particular pattern. The surface finish, even when textured, is limited in its presentation.

Embodiments of coatings and methods of applying such coatings are described herein. The coatings have improved texture characteristics, and can allow specialized and highly complex patterns to be printed onto substrates. It shall be understood that while sheet metal is used herein as the substrate to which the coating is applied, any type of substrate may be coated with the coatings and according to the methods described herein. Acceptable substrates include but are not limited to sheet metal (as described herein), aluminum, galvanized aluminum, stainless steel, plastic polymers, etc. Moreover, the substrates can be utilized in the formation of many types of products, including but not limited to siding, shingles, shelving, jackets for home and commercial appliances, entry doors, interior molding, furniture, etc.

According to embodiments of the invention, the coating includes a first layer comprising an ink and a second layer comprising a top coat. As used herein, “ink” may include traditional inks used in the printing industry, as well as paints or other coatings which may be used to apply a color or texture to a surface. Unaltered, the top coat is configured to develop a visible texture upon curing. The ink comprises an active ingredient that prevents the top coat from developing the texture. Therefore, due to the altered properties of the top coat when it contacts the ink, it is possible to create a textured surface that resembles a specific pattern or image. For example, and as is described in greater detail herein, the coating may be applied to a substrate to resemble a woodgrain pattern, and a texture may develop on the substrate that resembles the texture of a piece of wood. The result is that the coated substrate may more closely resemble the look of the article that the substrate is meant to emulate. While it was generally understood that the ink and top coat could be deposited onto a substrate in a manner that creates a textured pattern, certain textured patterns or designs were not as aesthetically pleasing as others with no immediate explanation for the discrepancy.

Several experiments were completed to determine why certain patterns presented better than others. To determine the answer, it was necessary to consider both the coating components (i.e., the ink and the top coat), and the means by which the pattern is applied to the substrate. Particularly interesting are the various engraving methods which are used to engrave cylinders, also referred to as rollers, in order to apply the coating to arrive at the final image. One method that is often utilized is gravure engraving. In gravure engraving, a cylinder is etched with a representation of an image and is then used to transfer ink onto the substrate. The process of etching the cylinder first requires a printer to develop an image. Using methods known in the industry, the image is then transferred to the cylinder as a plurality of cells, typically between 100 and 200 cells per inch. Cells that are larger in size, or deeper, will transfer more ink onto the substrate, while cells that are smaller in size, or shallower, will transfer less ink. The cells may be uniform or variable in size and/or distance from one another. The final print may be influenced by the size and spacing of the cells.

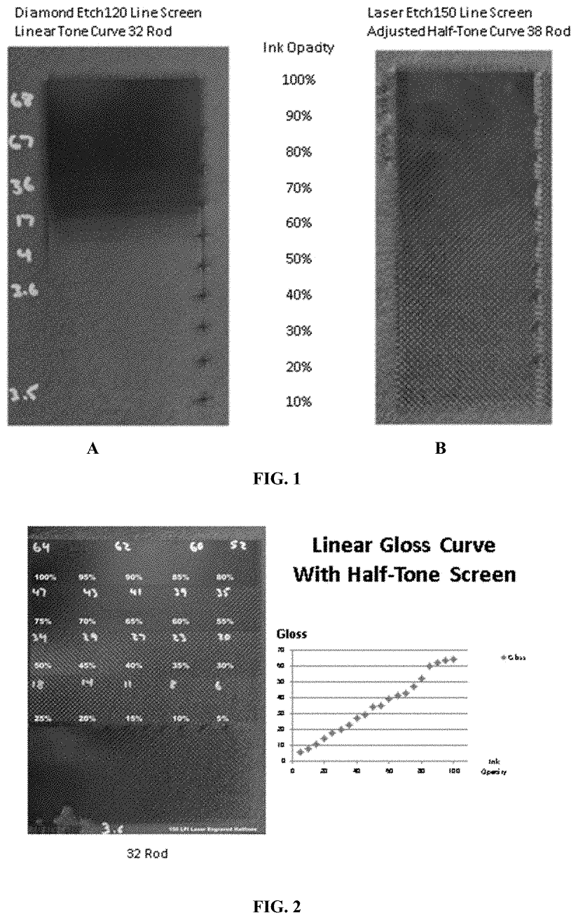

FIG. 1 illustrates two gray scale drawdown line screens coated with the ink and top coat described herein. The first, shown at the left as image A was developed from an ink transfer tool (e.g., similar to a cylinder) etched using a diamond etching technique to have 120 cells per inch. The second, shown at the right as image B was developed from an ink transfer tool etched using a laser etching technique to have 150 cells per inch. In image A, the cells are equidistant; however, the size of the cells is variable based on the desired amount of ink transfer. Here, the size of the cells etched into the transfer tool generally increases from bottom to top; in other words, at the bottom, less ink is transferred to the substrate (representing less ink opacity), and at the top, more ink is transferred to the substrate (representing greater ink opacity). On the other hand, in image B, the cells are all the same size while the distance between the cells varies. Here, the distance between the cells etched into the transfer tool increases from top to bottom; in other words, there are more cells at the top than at the bottom.

The ink was first applied to the substrate in each of images A and B. A top coat was subsequently applied over the entire substrate in order to arrive at the respective images. The results were surprising. In image A, the ink, which appears as the black portion in the image, has almost no effect on the top coat, which appears as the grey portion, until the ink opacity reaches about 60-65%. At less than 65% opacity, almost no ink is seen through the top coat, but at about 65% percent opacity, the top coat has almost no effect on the ink. Therefore, the ink has either no effect on the top coat, or the ink overwhelms the top coat and has a complete effect.

In image B, however, one observes a more gradual gradation of color. As the distance between the cells decreases from bottom to top, or alternately the number of cells per inch increases, the ink has a greater effect on the top coat. The result is a wide transition area that develops between areas of low ink opacity (approximately 10% opacity) and areas of high ink opacity (approximately 100% opacity). In image B, there is a high dynamic range of colors within the gray scale, as many different colors, or color tones, can be distinguished within the transition area. This is in direct contrast to image A, which exhibits a low dynamic range displaying high contrast—either white or black, depending on the percentage ink opacity.

Notably, when the top coat cures and texture develops, the gloss from the top coat is reduced in the area of the texture. Where ink prohibits the top coat from developing texture, the gloss in that area of the print is increasingly visible. FIG. 2 shows a linear gloss curve for the laser etched half-tone line screen in image B in FIG. 1. FIG. 2 clearly shows that as the opacity increases (or the amount of ink increases), the gloss also increases because the texture development of the top coat decreases. A linear curve on the gloss for the diamond etched line screen could not be achieved.

Images A and B in FIG. 1 illustrate that the amount of ink does not have a significant impact on the final image. Rather, it is the spacing between the cells that creates a printed image having high dynamic range, or the ability to distinguish between many different colors in a single image. Further, FIG. 2 shows that it is possible to achieve a linear gloss curve with a laser etching technique. Based on this information, specific patterns may be designed to take advantage of each etching technique. In embodiments, diamond etching may be utilized to design patterns exhibiting areas of high contrast. In other embodiments, laser etching may be utilized where the printed pattern will have a high dynamic range. Still in other embodiments, it may be desirable to utilize a combination of diamond etching and laser etching for a single print. By dictating a specific engraving profile, or a specific combination of engraving profiles, it may be possible to design patterns that were previously unable to be printed, or unable to be printed so as to provide a specific aesthetic.

In addition to the ability to design images based on the tone curve of an image, patterns may additionally be developed that take advantage of any effects that the ink may have on the top coat even where the ink does not directly underlie the top coat. In other words, in certain designs, it appeared that a texture in the top coat did not completely develop in areas void of ink, even though the top coat is configured to develop a texture absent the ink. Accordingly, the effect of the ink on the top coat was further studied.

Several sections of coated substrate were reviewed under a microscope. Surprisingly, it was found that a cured coating exhibits certain predictable attributes in areas near, but devoid of, ink which can be exploited to design and apply new and unique patterns. Specifically, the microscope showed that rather than developing full texture at areas devoid of ink, a halo, or area having a more rippled texture, develops at an edge of the ink that extends into the area devoid of ink. In other words, the ink appears to affect the curing properties of the top coat even in areas where no ink is present.

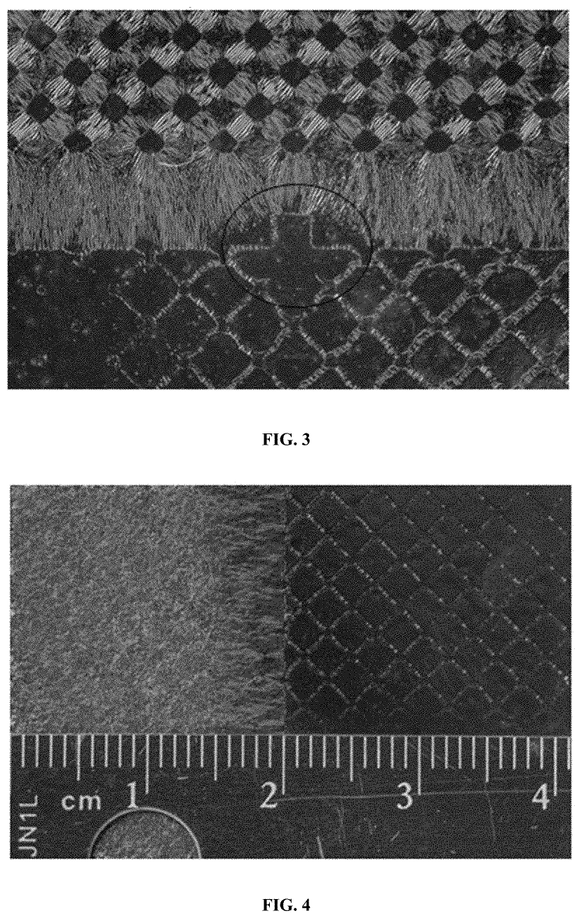

FIGS. 3 and 4 are images of a microscopic view of exemplary pieces of substrate partially coated in an ink and a top coat. In FIG. 4, the ink, appearing as black sections in the photo, is applied in a pattern starting at approximately 2 inches. Only a very small amount of texture develops where the ink is applied in the voids between the sections of ink, i.e., from 2 inches on, and the texture clearly follows the pattern of the ink. In the area where ink is not applied to the substrate, a texture clearly develops on the substrate from the edge of the image to about 1.5″. However, as the top coat nears the area of the substrate where the ink is applied, at about 1.5-2.0″, the texture is less developed. Here, the ink appears to pull on the top coat creating a rippled texture in the top coat, which extends perpendicularly away from the edge of the ink on the substrate for about 3-4 mm. These generally straight ripples create a halo effect between the area of the substrate that is fully textured, and the area of the substrate that is generally non-textured.

Interestingly, it was found that ink applied to the substrate having right angles (at or approximately 90°) does not impart the same halo effect. This is illustrated in FIG. 3. In FIG. 3, each of the small dark areas are areas of ink, and the lighter areas are areas of texture formed by the top coat. Focusing on the area in the middle of the image inside the circle, it can be seen that the ink was applied in the shape of a top hat, such that a right angle (i.e., a substantially 90° angle) is formed on either side of the “flue”. Based on the knowledge about how the ink influences the top coat even where ink is not present from FIG. 4, it was thought that the top coat would develop at least some texture near the ink. However, surprisingly it was found that inside of the right angle, there is total effect on the top coat. Whereas a texture develops in areas devoid of ink, and a rippled texture typically develops in a substantially straight line extending from a straight edge of the ink, no texture developed in the area of the right angle. The behavior of the top coat in areas around ink applied to form right angles can therefore also be used to develop patterns having specific texture profiles.

While the microscopic qualities of the halo effect are not visible to the human eye, the halo effect changes the visual characteristics of the pattern because the transitional area between the area of full-texture and the area of no-texture can appear fuzzy. Based on this understanding, it may be possible to design patterns that can take advantage of the aesthetic qualities of the halo effect. However, in other embodiments, such aesthetics are not desired.

Accordingly, in embodiments, it is desirable to negate the halo effect entirely. It was found that by reducing the amount of the active ingredient in the ink, the halo effect can be substantially, if not completely, negated. This is because by reducing the active ingredient in the ink, it may be possible to reduce the thickness of the coating applied to the ink and still achieve a textured surface on the substrate. Typically, coatings applied to a substrate have a thickness of about 0.6-0.9 mils. But in order to achieve the desired textured surface with the ink and top coat, it was determined that the coating thickness must be increased to 1.0-1.4 mils. Such a thickness of the coating creates numerous issues in the process, including the development of blisters on the top coat, and heavy edge blisters on the edge of the strip. Additionally, the process of applying a thick coating is more complicated and time consuming. Accordingly, it was determined that it is impractical to apply a thick coating to the substrate. Through testing, it was determined that by decreasing the active ingredient in the ink, and decreasing the thickness of the top coating, it may be possible to almost completely mitigate the tendency for blisters to develop on the substrate. Additionally, it was found that by reducing the coating thickness and the efficacy of the active ingredient, the halo effect was almost completely negated. At the same time, the textured surface that develops is still desirable when compared to other textured coatings.

Development of textured patterns is therefore directly dependent on how the ink is applied to the substrate. In patterns exhibiting a wide tone curve, or substantially equal areas of ink opacity distributed throughout the image, such as in image A in FIG. 1, the texture development is muted. On the other hand, in patterns exhibiting a narrow tone curve, or high contrast between darks and lights, the texture development may be quite dynamic. During the development of designs for textured patterns, it must therefore be taken into account that the top coat is not influenced by the amount of ink applied to the substrate under the top coat. Accordingly, if it is desired to recreate a specific image onto the sheet metal, and a texture is desired as part of that image, ink cannot be distributed over the entirety of the substrate. In other words, it is not enough to simply increase or decrease the amount of ink applied to the substrate based on the colors in the original image because the presence of ink, no matter how much, prevents texture formation. Rather, the ink must be distributed onto the substrate in a particular pattern based on the characteristics of how the ink influences the development of the texture of the top coat.

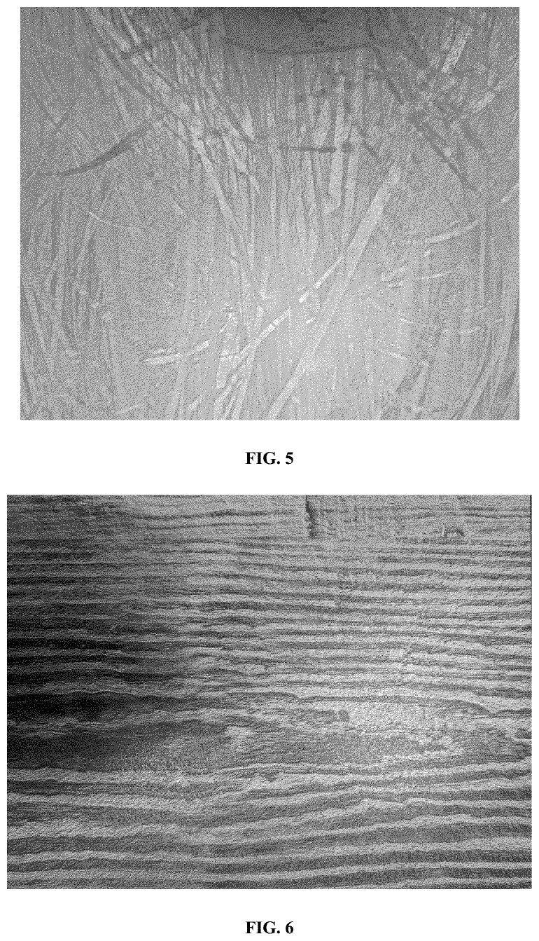

FIG. 5 is a photograph of a section of sheet metal having a pattern printed thereon which resembles grass. According to a method of the invention, the pattern was developed from several pictures that were combined to form a single image. The tone curve of the image was then adjusted to create a greater contrast ratio between the darks areas and the light areas in the image. A cylinder was then engraved according to a specific engraving profile for the image. The cell depth and size of the engraving profile was dictated to maximize the ink transfer efficiency. Importantly, the engraving profile may not be identical to the image. Rather, the profile may be altered to take into account the effect that the ink has on the development of texture in the top coat as described herein.

As noted herein, reproduction of images into patterns for printing is perhaps best achieved from images that have a narrow tone curve—images with mostly light and dark areas. Images with a wide tone curve, or images with light and dark areas and a significant amount of middle tones in between, are significantly more difficult to duplicate because of how the ink affects the top coat.

With these predictable characteristics in mind, according to a method of the embodiment, a coating comprising a first layer comprising an ink and a second layer comprising a top coat is applied to a substrate according to a predetermined pattern. The method comprises preparing the gravure cylinder with the pattern, preferably utilizing a laser etching technique, although other techniques may additionally or alternately be utilized.

Once the cylinder is adequately prepared, the coating may be roll-applied to the prepared sheet metal according to methods known in the industry. In an embodiment, the gravure cylinder picks up ink held in an ink plate. A doctor blade scrapes off any access ink from the gravure cylinder. The gravure cylinder then contacts an applicator roll, transferring ink from the gravure cylinder to the applicator roll. The applicator roll then contacts the sheet metal to transfer the ink pattern onto the sheet metal. The top coat is then roll-applied to the sheet metal over the wet ink, and the sheet metal is passed through an oven. During the dwell time in the oven, the ink and the top coating cure, and texture is developed in the areas without ink. The dwell time in the oven is critical to ensure the most dynamic texture, and therefore the sheet metal may pass through the oven at speeds ranging from about 200 to about 400 ft/min., and more preferably, at about 250 ft/min. The dwell time of the substrate in the oven can range from approximately 30 to 50 seconds, and more preferably, between 30 and 40 seconds.

It shall be understood that patterns can be developed for printing on a substrate which may not be intended for aesthetic purposes. For example, because the ink and top coat can be applied in such a way as to create a textured pattern that is predictable, print patterns can be used to provide communication capabilities to the substrate. For example, braille could be printed onto the substrate utilizing the predictable development of the texture. Whereas historically patterns have been relatively “flat”, or a texture may appear to the eye but cannot be felt, the patterns developed according to the invention described herein have a true texture which is tactile and ascertainable by a consumer.

Further, those of skill in the art shall understand that the system can be single color, or multi-color. FIG. 5 illustrates a single color pattern. Here, the top coat is clear. The texture is immediately visible to the naked eye because the glossy nature of the top coat is altered by the texture that develops. FIG. 6 illustrates a dual color pattern. Here, a light colored base coat is applied to the substrate, and a darker colored ink is applied over top of the base coat. A clear top coat is then applied over the base coat and the ink. A texture develops in the areas without ink. However, due to the high contrast between the light and dark colors, the eye is drawn away from seeing the texture, and instead sees the vibrant pattern. However, the substrate tactilely exhibits a textured surface.

Many different arrangements of the described invention are possible without departing from the spirit and scope of the invention. Embodiments of the invention are described herein with the intent to the illustrative rather than restrictive. Alternative embodiments will become apparent to those skilled in the art that do not depart from its scope. A skilled artisan may develop alternative means of implementing improvements without departing from the scope of the invention.

Further, it will be understood that certain features and subcombinations are of utility and may be employed without reference to other features and subcombinations and are contemplated within the scope of the claims. Not all steps listed in the various figures and description, if any, need to be carried out in the specific order described. The description should not be restricted to the specific described embodiments.

1. A method for providing a textured surface finish to a substrate, comprising:
(1) providing an image having a contrast ratio;
(2) altering the image to increase the contrast ratio;
(3) determining an engraving profile for an ink transfer tool based on the contrast ratio of the image;
(4) etching the ink transfer tool in accordance with the engraving profile;
(5) coating the ink transfer tool with an ink;
(6) transferring the ink from the ink transfer tool to a substrate;
(7) applying a top coat to the substrate while the ink is set; and
(8) curing the ink and top coat on the substrate in an oven;
wherein:
the etching creates a plurality of wells in the ink transfer tool for holding the ink; and
the engraving profile is not identical to the altered image.

2. The method of claim 1, wherein the curing occurs by passing the substrate through an oven to reach 450 deg. F.

3. The method of claim 2, wherein a dwell time of the substrate in the oven is about 30-40 seconds.

4. The method of claim 1, wherein the transfer tool is diamond etched.

5. The method of claim 1, wherein the transfer tool is laser etched.

6. The method of claim 1, wherein the transfer tool is etched using a combination of diamond etching and laser etching.

7. The method of claim 1, further comprising coating the substrate in a base coat prior to transferring the ink onto the substrate.

8. The method of claim 7, wherein the base coat comprises a light pigment.

9. The method of claim 8, wherein the ink comprises a dark pigment.

10. A method for providing a textured surface finish to a substrate, comprising:
(1) providing an image having a contrast ratio;
(2) altering the image to increase the contrast ratio;
(3) determining an engraving profile for an ink transfer tool based on the contrast ratio of the image;
(4) etching the ink transfer tool in accordance with the engraving profile;
(5) coating the ink transfer tool with an ink;
(6) coating a substrate in a base coat;
(7) transferring the ink from the ink transfer tool to the substrate;
(8) applying a top coat to the substrate while the ink is set; and
(9) curing the ink and top coat on the substrate in an oven;
wherein the etching creates a plurality of wells in the ink transfer tool for holding the ink.

11. The method of claim 10, wherein the engraving profile is not identical to the altered image.

12. The method of claim 11, wherein the transfer tool is etched via at least one of diamond etching and laser etching.

13. The method of claim 12, wherein the substrate is cured in an oven for approximately 30-40 seconds.

14. The method of claim 10, wherein the base coat is a light pigment.

15. The method of claim 14, wherein the ink is a dark pigment.

16. A method for providing a surface finish to a substrate, comprising:
(1) providing an image having a contrast ratio;
(2) determining an image profile for an ink transfer tool based on the contrast ratio of the image;
(3) preparing the ink transfer tool in accordance with the image profile, wherein the preparation includes defining a plurality of wells in the ink transfer tool;
(4) coating the ink transfer tool with an ink, wherein the ink is retained in the wells;
(5) transferring the ink from the ink transfer tool to a substrate;
(6) applying a top coat to the substrate; and
(7) curing the substrate in an oven.

17. The method of claim 16, wherein transferring the ink from the ink transfer tool to the substrate results in at least one area of ink defining an angle of approximately 90°.

18. The method of claim 16, wherein at least a portion of the substrate is devoid of ink after transferring the ink from the ink transfer tool to the substrate.

19. The method of claim 16, wherein the transfer tool is etched via at least one of diamond etching and laser etching.

20. The method of claim 16, wherein the image profile is not identical to the image having a contrast ratio.
